(19) United States
(12) Patent Application Publication
(10) Pub. No.: US 2009/0165061 A1
(43) Pub. Date: Jun. 25, 2009

(54) PLAYBACK CONTROLLING APPARATUS AND IMAGE PROCESSING APPARATUS

(75) Inventor: Joji Yamashita, Hachioji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/330,400

(22) Filed: Dec. 8, 2008

(30) Foreign Application Priority Data
Dec. 25, 2007 (JP) 2007-332798

(51) Int. Cl. H04N 7/18

(52) U.S. Cl. 725/82

(57) ABSTRACT

A playback controlling apparatus communicably connectable to a plurality of image processing devices via a first communication scheme and a second communication scheme. The apparatus includes: a first transmission module configured to transmit request information to the image processing devices via the first communication scheme, wherein the request information is for requesting address information; a receiving module configured to receive address information via the second communication scheme from one of the image processing devices; and an association module configured to associate the address information with the one of the image processing devices.

### CROSS-REFERENCE TO RELATED APPLICATIONS

This application is based upon and claims the benefit of priority from Japanese Patent Application No. 2007-332798, filed Dec. 25, 2007, the entire contents of which are incorporated herein by reference.

### BACKGROUND

1. Field

One embodiment of the invention relates to a playback controlling apparatus for controlling playback of contents data in an image processing device, as well as to an image processing apparatus that plays back contents data under control of a playback controller.

2. Description of Related Art

In recent years, as an IP network, such as a home network, has come into wide use, a technique gets widely used to play back contents data stored in a database server connected to the home network by using a plurality of display devices (renderers) connected to the home network. In such a case, a controller is usually connected to the home network, and the controller controls playback of contents data in the respective renderers.

For instance, JP-A-2004-96280 discloses a method for performing content remote-playback processing when a remote controller is set as a client. Under the remote playback method, a client device requests a media renderer to set a control instance for allowing remote control, and the media renderer sets a control instance responsive to the request and controls playback of contents data in accordance with the control request from the client that has designated the control instance.

When an image processing device (a renderer) and a database server, which are connected to the same network, are controlled by a control device (a controller) connected to the server, the user must select an image processing device to be controlled by the controller even when the image processing device and the controller are disposed in front of the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system configuration diagram showing a network system to which a playback controller and an image processing device of one embodiment are applied;

FIG. 2 is a block diagram showing the configuration of the playback controller;

FIG. 3 is a block diagram showing the configuration of the image processing device;

FIG. 4 is a block diagram showing the configuration of a storage device;

FIG. 5 is a view for describing a first embodiment of the playback controller and the image processing device;

FIG. 6 is a flowchart showing procedures employed when the playback controller of performs playback control processing of the first embodiment;

FIG. 7 is a sequence diagram showing the flow of data achieved when the playback controller and the image processing device of the present invention performs the playback control processing of the first embodiment;

FIG. 8 is a flowchart showing procedures employed when the image processing device of the present invention performs first embodiment of playback processing;

FIG. 9 is a sequence diagram showing the flow of data achieved when the playback controller and the image processing device performs the playback control processing of the first embodiment,

FIG. 10 is a flowchart showing procedures employed when the image processing device performs playback processing of the first embodiment;

FIG. 11 is a view for describing a second embodiment of the playback controller and the image processing device;

FIG. 12 is a flowchart showing procedures employed when the playback controller of performs playback control processing of the second embodiment;

FIG. 13 is a view for describing a third embodiment of the playback controller and the image processing device;

FIG. 14 is a data block diagram showing an example of management information; and

FIG. 15 is a flowchart showing procedures employed when the playback controller performs playback control processing of the third embodiment.

### DETAILED DESCRIPTION

Various embodiments according to the invention will be described hereinafter with reference to the accompanying drawings. In general, according to one embodiment of the invention, a playback controlling apparatus communicably is connectable to a plurality of image processing devices via a first communication scheme and a second communication scheme. The apparatus includes: a first transmission module configured to transmit request information to the image processing devices via the first communication scheme, the request information for requesting address information; a receiving module configured to receive address information via the second communication scheme from one of the image processing devices; and an association module configured to associate the address information with the one of the image processing devices.

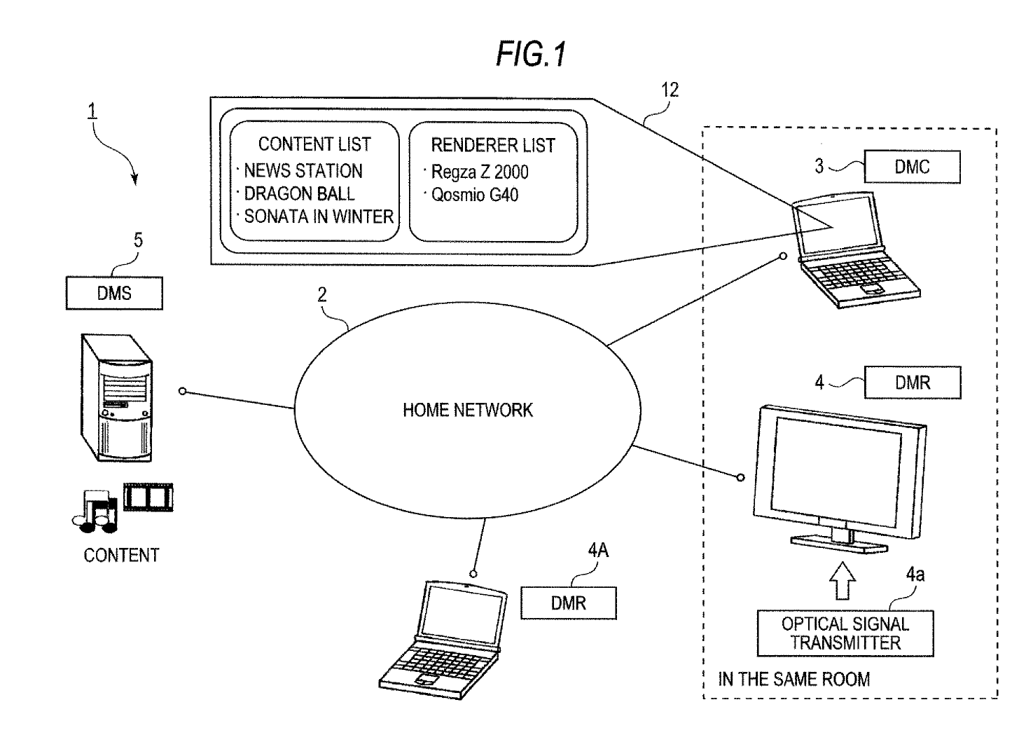

FIG. 1 is a system block diagram of a network system 1 to which a playback controller 3 and image processing devices 4 and 4A of the present invention are applied. As shown in FIG. 1, the network system 1 has a home network 2. The playback controller 3 for controlling playback of contents, the plurality of image processing devices 4 and 4A that play back contents under control of the playback controller 3, and a storage device 5 that stores the contents played back by the image processing devices 4, 4A are connected by means of a communication scheme using the home network 2.

The playback controller 3 and the image processing devices 4 and 4A are connected to each other by means of a communication scheme using optical communication. Optical communication is data communication using; for instance, infrared radiation, visible radiation, and the like. In the accompanying drawings, the playback controller 3 is denoted as “DMC”; the image processing device 4 is denoted as “DMR”; and the storage device 5 is denoted as “DMS.”

The image processing device 4 has an optical signal transmitter 4a for remotely controlling the image processing device 4. Upon receipt of an optical signal from the optical signal transmitter 4a, the image processing device 4 performs various processing operations in accordance with the optical signal. As for the optical signal transmitter 4a, the image processing device 4 is, for instance, a television, and the optical signal transmitter 4a is a remote controller (a remote control module) for operating the television. The home network 2 is an Internet Protocol (IP) network, such as an Ethernet (Registered Trademark). In the IP network, the minimum module for conducting communication of communication terminals, network devices, and the like, is called a “node,” and an IP address is used as identification information for locating a node of a party at the other end of communication. The playback controller 3 controls the image processing device 4 to play back contents data stored in the storage device 5 through the home network 2.

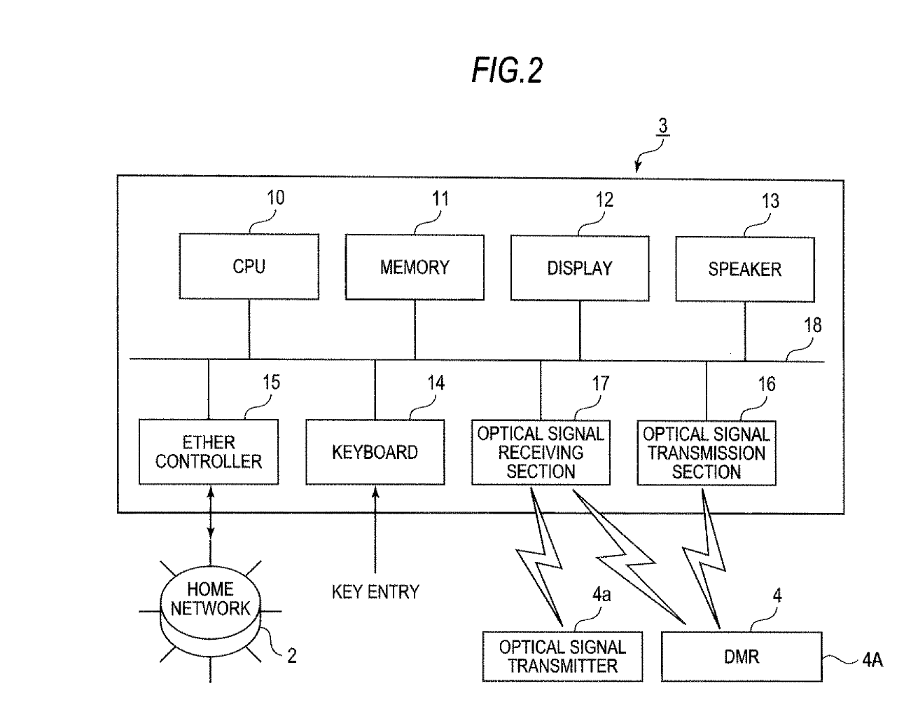

FIG. 2 is a block diagram of the playback controller 3. The playback controller 3 is; for instance, a personal computer (PC), a personal digital assistant (PDA), and a portable terminal. As shown in FIG. 2, a central processing unit (CPU) 10 for controlling the overall playback controller 3; a memory 11 that temporarily stores data as a work area at the time of processing operation of the CPU 10; a display 12 that displays a result of processing performed by the CPU 10, a status, and the like; a speaker 13 that outputs a result of processing performed by the CPU 10, a status, and the like, by voice; a keyboard 14 that inputs a command on which the CPU 10 performs processing; an Ether controller 15 that converts communication data into a protocol of the home network 2 at the time of communication performed by way of the home network 2; a first optical signal transmission section 16 that transmits an optical signal to the image processing device 4; a second optical signal receiving section 17 that receives an optical signal from the optical signal transmitter 4a or the image processing device 4, are connected in a mutually-communicable manner by way of a bus 18.

The memory 11 stores a list of contents data stored in the storage device 5 and a renderer list (a list of image processing devices connected to the home network 2). The display 12 and the keyboard 14 may also be a touch panel that inputs a command for the CPU 10 when the user presses a portion of a display screen. The content list and the renderer list stored in the memory 11 are displayed on the display 12, and contents data or an image processing device is selected by means of a user's input at the keyboard 14. The playback controller 3 performs playback control processing in accordance with the user's input at the keyboard 14.

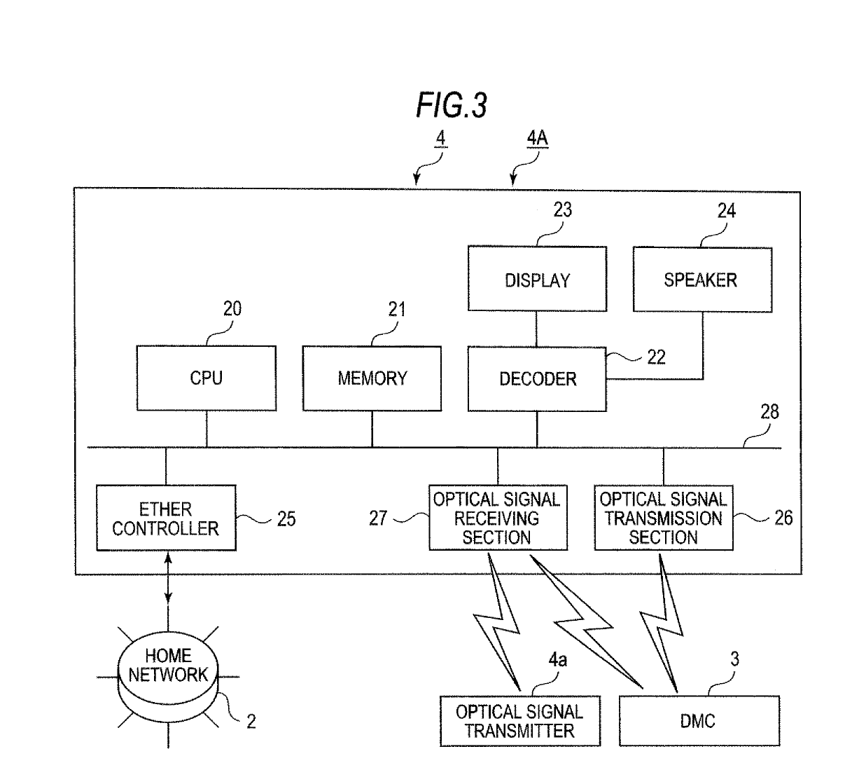

FIG. 3 is a block diagram of the image processing devices 4 and 4A. The image processing devices 4 and 4A are devices that decode an image for a television set or a PC and display the thus-decoded image. As shown in FIG. 3, a CPU 20 that controls the overall image processing devices 4 and 4A; a memory 21 that temporarily stores data as a work area at the time of processing operation of the CPU 20; a decoder 20 that decodes a packet received by way of the home network 2, converts display data into a format which can be displayed on a display 34, and converts audio data into a format which can be output as audio from the speaker 24; an Ether controller 25 that converts communication data into a protocol of the home network 2 during communication performed by way of the home network 2; a first optical signal transmission section 26 that transmits an optical signal to the playback controller 3; and a second optical signal receiving section 27 that receives an optical signal from the optical signal transmitter 4a or the playback controller 3 are connected in a mutually-communicable manner by way of the bus 28.

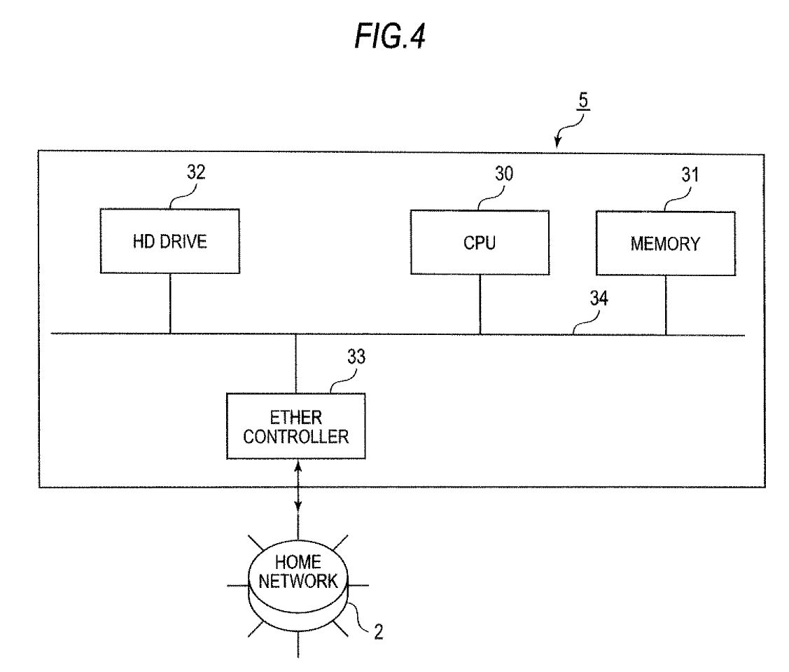

FIG. 4 is a block diagram of the storage device 5. The storage device 5 is a database server that transmits and receives data in accordance with a request from; for instance, the playback controller 3 and the image processing device 4. As shown in FIG. 4, a CPU 30 that controls the overall storage device 5; a memory 31 that temporarily stores data as a work area at the time of processing operation of the CPU 30; a hard disk (HD) drive 32 for storing a plurality of contents; and an Ether controller 33 that converts communication data into the protocol of the home network 2 at the time of communication through the home network 2 are connected in a mutually-communicable manner by way of a bus 34. IDs are assigned to respective contents stored in the HD drive 32, and the playback controller 3 or the image processing device 4 can acquire desired contents from the storage device 5 by designation of an ID.

The word “contents” used herein means video data consisting of display data and audio data, and the like. After acquiring information (content request information “d” to be described later) for requesting contents, the storage device 5 transmits contents (content information “e” to be described later) in accordance with the information.

As shown in FIG. 1, in the network system 1, the plurality of image processing devices 4 and 4A are assumed to be connected to the home network 2, and only the image processing device 4 of these devices is assumed to be set in the same room where the playback controller 3 is disposed. Conventionally, when the image processing device 4 and the storage device 5 connected to the same home network 2 are controlled by the playback controller 3 connected to the same home network 2, the user must set the image processing device 4 as an object of control by using the playback controller 3, even when the image processing device 4 to be controlled is disposed in front of the playback controller 3 that performs control.

For instance, when the user desires to bring the playback controller 3 in a room where only one image processing device 4 is disposed and to cause the image processing device 4 to display (play back) contents stored in the storage device 5, the user must take the trouble to select the image processing device 4 by using the playback controller 3 regardless of the fact that the user is sure which the image processing device 4 is to be controlled. It may be possible to utilize a pairing function implemented by Bluetooth as a method for specifying a device to be controlled. However, in this case, there is a possibility of detecting the image processing device 4A set in a room different from the room where the playback controller 3 is disposed. Also the number of devices that can be subjected to pairing may be limited.

Accordingly, in the network system 1, the playback controller 3 acquires an address (a MAC address or an IP address) from the image processing device 4 that is a target of control and automatically selects the target image processing device 4 by the playback controller 3 through use of the address, thereby facilitating user's input operation.

### First Embodiment

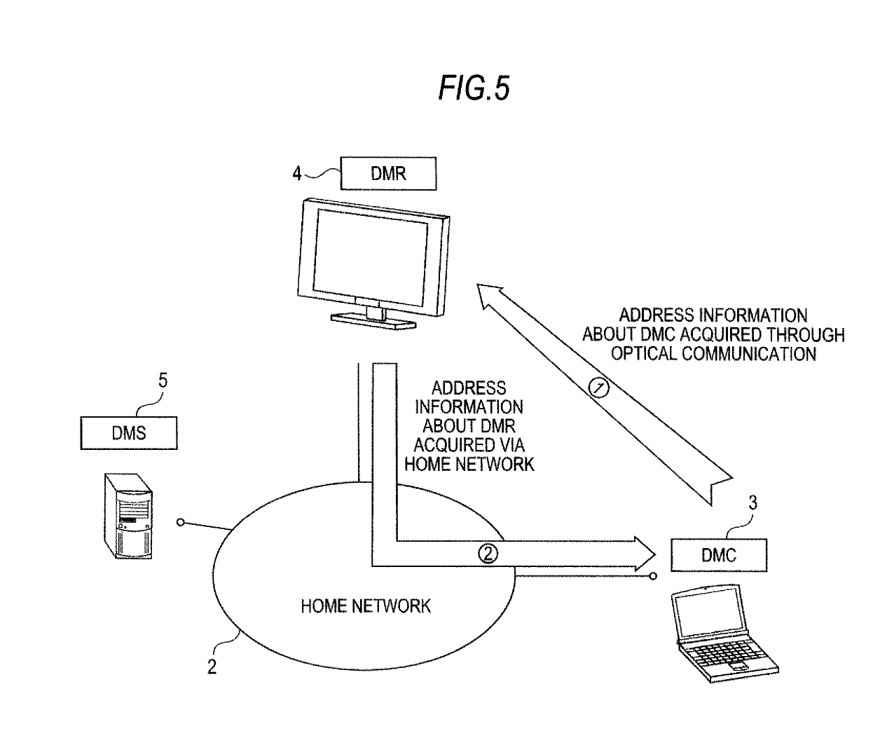

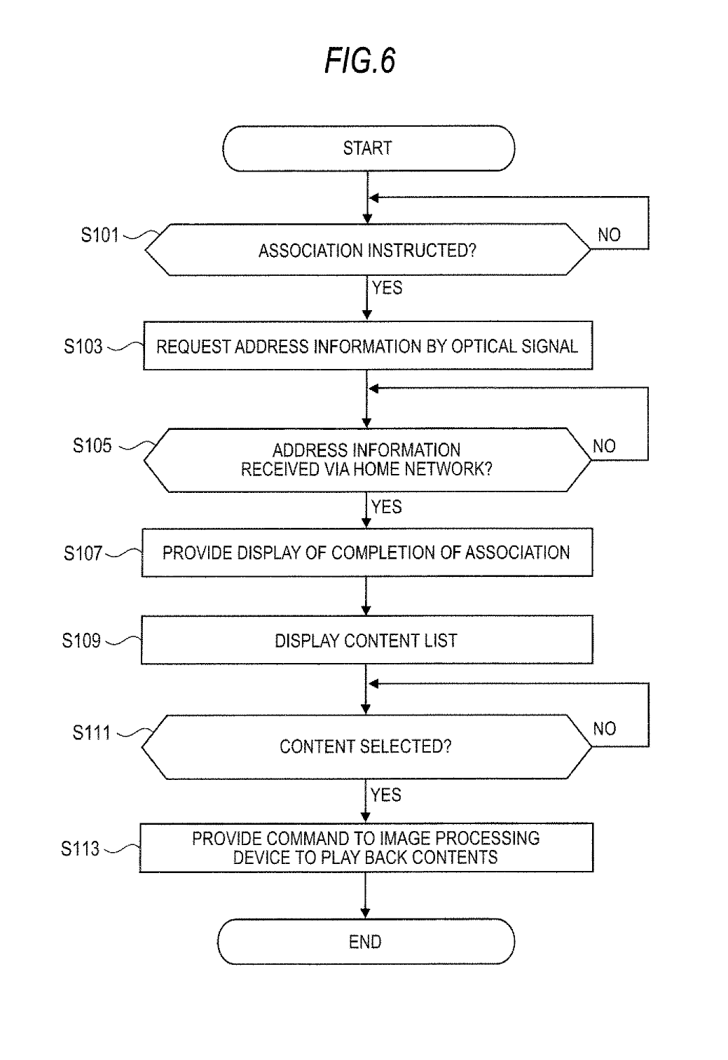

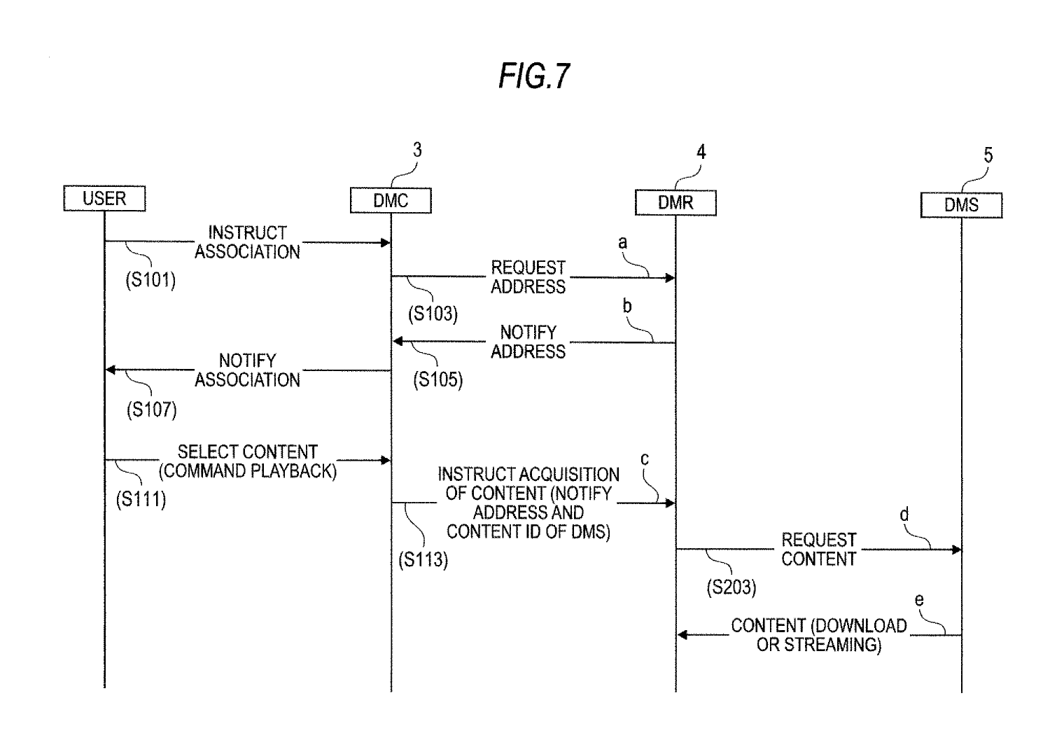

A first embodiment of the playback controller 3 and the image processing device 4 will be described by reference to FIGS. 5 through 9. As shown in FIG. 5, the playback controller 3 transmits an optical signal to the image processing device 4 set in the same room, thereby acquiring address information about the image processing device 4 through the home network 2 and subjecting the image processing device 4 to playback control processing. Steps of performing playback control processing by the playback controller 3 performs will be described below with reference to a flowchart shown in FIG. 6 and a sequence chart shown in FIG. 7. Step S101 is hereunder described by omitting a word “step” like S101. Further, respective steps in the flowchart are assumed to correspond to respective steps in the sequence chart.

When the image processing device 4 plays back contents under control of the playback controller 3, it is necessary for the playback controller 3 to associate the image processing device 4 that actually performs playback processing with address information of the image processing device 4. When the user desires to play back contents on the image processing device 4, the user issues a command for association to the playback controller 3 by means of an input, or the like, at the keyboard 14 of the playback controller 3. Accordingly, the CPU 10 of the playback controller 3 first determines whether or not the user has instructed association of the image processing device 4 that actually performs playback processing with address information about the image processing device 4 (S101). When association is not instructed (No in S101), the CPU 10 continues to stay in a standby condition.

When an association is instructed (Yes in S101), the CPU 10 requests the image processing device 4 to transmit address information (S103). As shown in FIG. 7, the playback controller 3 transmits address request information “a”, by an optical signal, for requesting address information from the optical signal transmission section 16. Since an optical signal transmitted at this time reaches only the same room, the signal is transmitted solely to the image processing device 4 set in the same room.

When the optical signal receiving section 27 of the image processing device 4 receives the address request information “a” transmitted from the playback controller 3 in step S103, the CPU 20 of the image processing device 4 transmits, by way of the Ether controller 25, address notification information “b” showing a MAC address or an IP address of the image processing device 4.

The CPU 10 determines whether or not the address information is transmitted from the image processing device 4 (S105). At this time, the CPU 10 is assumed to have received address information from the image processing device 4 on the basis of the fact that the address notification information “b” has been received by the Ether controller 15. When address information is not received from the image processing device 4 (No in S105), the CPU 10 stays in a standby condition until address information is received.

When address information is received (Yes in S105), the CPU 10 provides a display as to completion of association of the image processing device 4 that actually performs playback processing with address information of the image processing device 4 (S107). Since the address request information “a” transmitted in step S103 is transmitted solely to the image processing device 4 situated in the same room, it is obvious that the address notification information “b” received in step S105 is information showing the address of the image processing device 4 situated in the same room. The image processing device 4 that actually performs playback processing is associated with the address information of the image processing device 4.

The CPU 10 displays the list of contents stored in the storage device 5 on the display 12 (S109). At this time, the CPU 10 provides a display in such a way that the user can select a desired content from the content list by an input at the keyboard, or the like.

The CPU 10 determines whether or not a content is selected (S111) When such a content is not selected (No in S111), the CPU 10 stays in a standby condition until a content is selected. When a content is selected (Yes in S111), the CPU 10 issues a command to the image processing device 4 to playback the content (S113). As shown in FIG. 7, the CPU 10 transmits, at this time, content acquisition command information “c” for instructing acquisition of the content selected in step S111 to the image processing device 4 through the Ether controller 15. The content acquisition command information “c” includes ID information of the content selected in step S111 and the address information about the storage device 5, and the image processing device 4 plays back the content in accordance with the information.

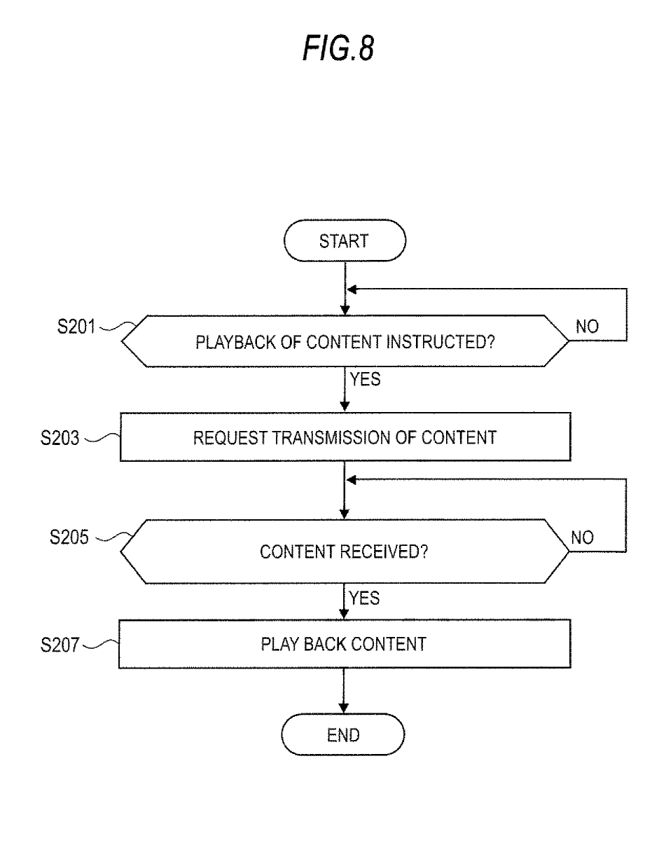

There will now be described steps of performing content playback processing by the image processing device 4 on the basis of acquisition of the content acquisition command information “c” by reference to a flowchart shown in FIG. 8 and a sequence diagram shown in FIG. 7.

The CPU 20 of the image processing device 4 determines whether or not playback of a content is instructed (S201). At this time, based on a fact that the content acquisition command information “c” transmitted in step S113 is received by the Ether controller 25, the CPU 20 determines that playback of a content has been instructed. When playback of a content is not instructed (No in S201), the CPU 20 continues to stay in a standby condition.

When playback of a content is instructed (Yes in S201), the CPU 20 requests the storage device 5 to transmit a content (S203). At this time, the CPU 20 determines, from the address information of the storage device 5 included in the content acquisition command information “c” received in step S113, the storage device 5 to receive the request, and also determines a content corresponding to the request from content ID information included in the content acquisition command information “c.”

As shown in FIG. 7, the CPU 20 transmits to the storage device 5 content request information “d” for requesting transmission of a content. The content request information “d” includes content ID information. The storage device 5 received the content request information “d” selects a content in accordance with the content request information “d” (ID information) and transmits content information “e” to a source (the image processing device 4) of the content request information “d.”

The CPU 20 determines whether or not the content is received (S205). At this time, the CPU 20 deems that a content has been received on the basis of a fact that the content information “e” is received from the storage device 5 through the Ether controller 25. When a content is not received (No in S205), the CPU 20 stays in a standby condition until a content is received.

When a content is received (Yes in S205), the CPU 20 plays back the content received by the Ether controller 25 (S207). The image processing device 4 decodes, at this time, the content information “e” received in step S207 by the decoder 22, displays the content on the display 12 in accordance with display data included in the content information “e,” and produces an audio output based on audio data from the speaker 24.

The playback controller 3 thus requests address information from the image processing device 4 by the use of an optical signal and receives the address information from the image processing device 4 via the home network, thereby associating the address information with the image processing device 4 that is to become a target of control. In accordance with the address information, the playback controller 3 controls the image processing device 4 to playback the content stored in the storage device 5.

When the address information is requested by the playback controller 3 through use of the optical signal, the image processing device 4 transmits the address information to the playback controller 3 through the home network, thereby playing back a content stored in the storage device 5 under control of the playback controller 3.

The first embodiment has described an exemplification of the playback controller 3 transmitting the content acquisition command information “c” to the image processing device 4 in step S113. However, the invention is not limited to the exemplification. The playback controller 3 may also output a command to the storage device 5 to play back a content.

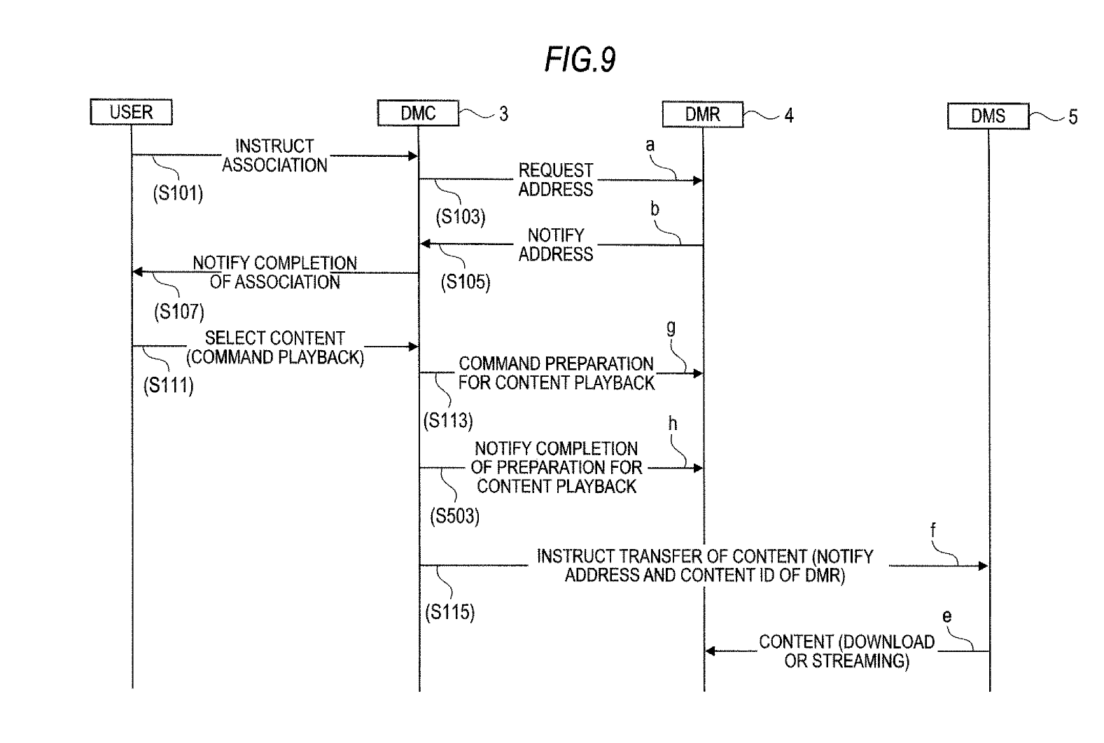

In this case, as shown in FIG. 9, the CPU 10 of the playback controller 3 transmits content playback preparation command information “g” to the image processing device 4 in step S113, thereby instructing a preparation for playback of a content. The CPU 20 of the image processing device 4 prepares for playback of a content on the basis of a fact of receipt of a command for preparation of content playback (the content playback preparation command information “g”) from the playback controller 3 and transmits content playback preparation completion notification information “h,” thereby notifying the playback controller 3 of completion of the preparation.

When the playback controller 3 has received, from the image processing device 4, the notification of completion of the preparation for content playback (the content playback preparation completion notification information “h”), the CPU 10 of the playback controller 3 transmits content playback command information “f” to the storage device 5 (S115). The content playback command information “f” includes the address information of the image processing device 4 acquired by the playback controller 3 in step S105 and the ID information about the content selected in step S111. In accordance with the content playback command information “f,” the storage device 5 transmits the content information “e” to the image processing device 4, and the image processing device 4 plays back the content.

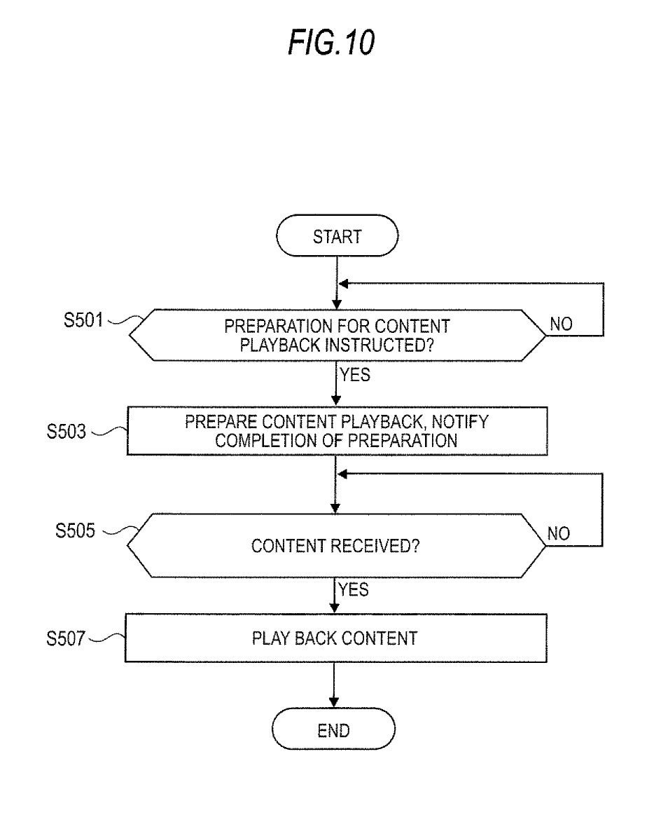

The image processing device 4 at this time plays back the content along a flowchart shown in FIG. 10. The CPU 20 of the image processing device 4 determines whether or not a preparation for playback of a content is instructed (S501). On the basis of a fact of receipt of the content playback preparation command information “g” from the playback controller 3, a preparation for content playback is deemed to be instructed. When the preparation for content playback is not instructed (NO in S501), the CPU 20 continues to stay in a standby condition.

When the preparation for content playback is instructed (Yes in S501), the CPU 20 prepares the playback of contents and transmits content playback preparation completion notification information “h,” thereby notifying the playback controller 3 of completion of the preparation (S503). The CPU 20 determines whether or not a content is received (S505). When a content is not received (No in S505), the CPU 20 stays in a standby condition until a content is received. When a content is received (Yes in S505), the CPU 20 plays back the received content.

According to the first embodiment of the playback controller 3 and the image processing device 4, on controlling the image processing device 4 by way of the home network 2 laid in the same room, the playback controller 3 can recognize the image processing device 4 disposed in the room among the plurality of image processing devices similarly connected to the home network 2.

### Second Embodiment

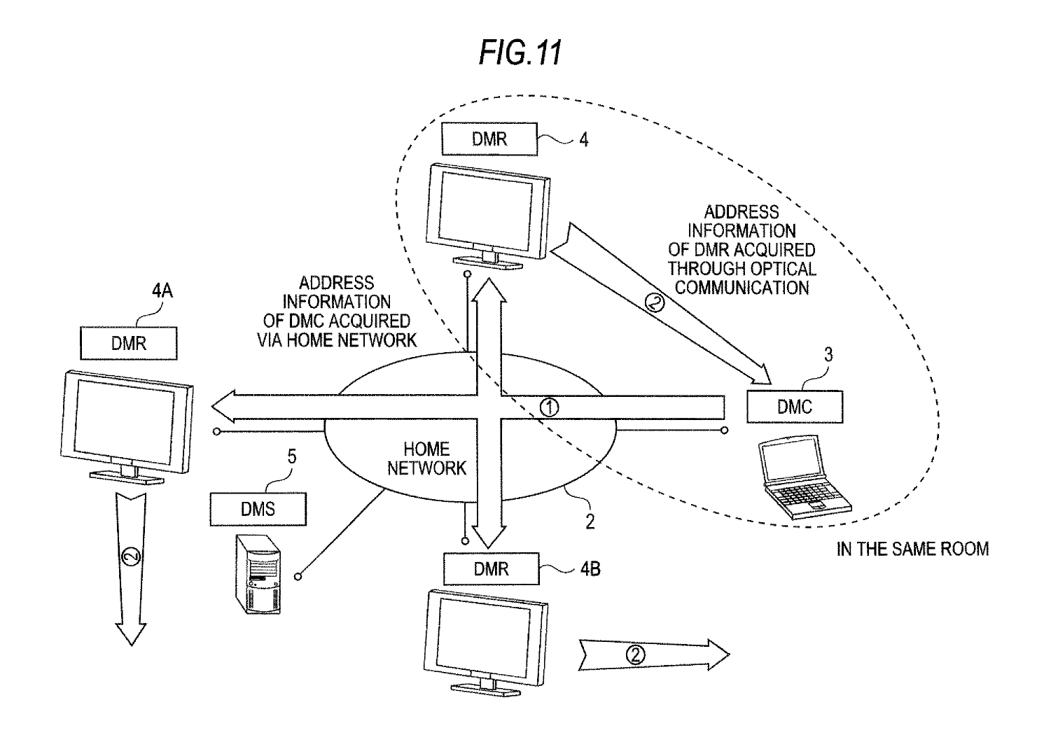

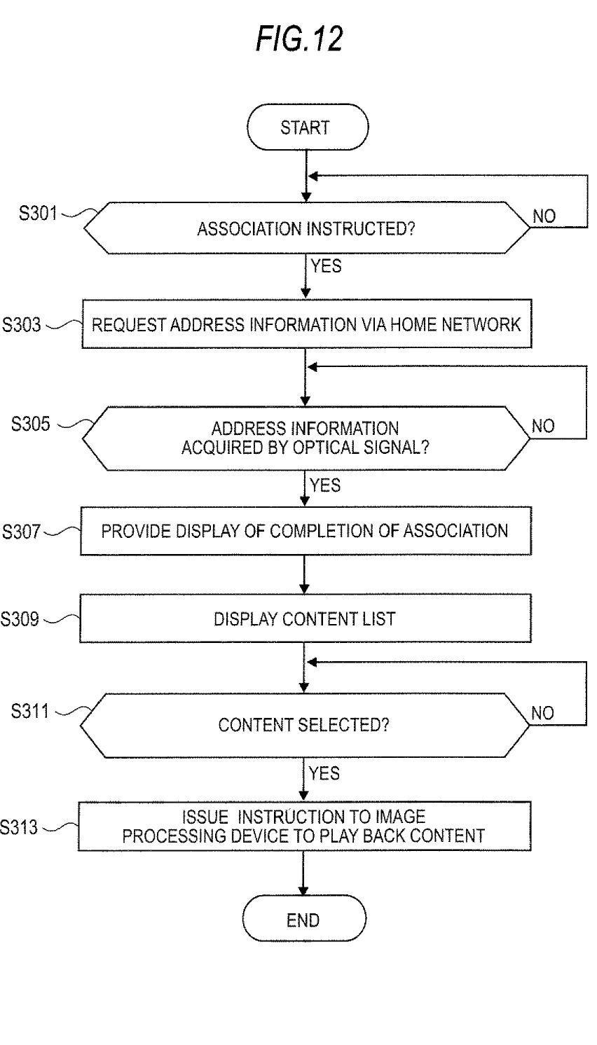

A second embodiment of the playback controller 3 and the image processing device 4 will be described by reference to FIGS. 11 and 12. As shown in FIG. 11, the playback controller 3 transmits, through the home network 2, request information for requesting address information to all image processing devices 4, 4A, and 4B connected to the home network 2 and receives address information from the image processing device 4 disposed in the same room by use of an optical signal, thereby acquiring address information about the image processing device 4 and subjecting the image processing device 4 to playback control processing. Steps of performing playback control processing by the playback controller 3 will be described with reference to a flowchart shown in FIG. 12 and the sequence diagram shown in FIG. 7.

When the image processing device 4 plays back the content under control of the playback controller 3, it is necessary for the playback controller 3 to associate the image processing device 4 that actually performs playback processing with address information about that image processing device 4. When the user wants to play back the content on the image processing device 4, the user operates the keyboard 14 of the playback controller 3 or the like to input an instruction so that the playback controller 3 issues a command for association. Accordingly, the CPU 10 of the playback controller 3 determines whether or not the user instructs the playback controller 3 to associate the image processing device 4 that actually performs playback processing with address information of the image processing device 4 (S301). When such an association is not instructed (No in S301), the CPU 10 continues to stay in a standby condition.

When association is instructed (Yes in S301), the CPU 10 requests the image processing device 4 to transmit address information (S303). On this occasion, as shown in FIG. 10, the playback controller 3 transmits address request information “a” for requesting address information to all image processing devices 4 connected to the home network 2 by way of the Ether controller 15

When the image processing devices 4, 4A, and 4B connected to the home network 2 have received the address request information “a” transmitted from the playback controller 3 in step S303 through the Ether controller 25, the CPUs 20 of these image processing devices 4, 4A, and 4B transmit, from the optical signal transmission sections 26, optical signals of address notification information “b” showing their MAC addresses or IP addresses.

The CPU 10 determines whether or not the address information has been received from the image processing device 4 (S305). The CPU 10 at this time deems, on the basis of a fact of receipt of the optical signal of the address notification information “b” through the optical signal receiving section 17, that the address information is received from the image processing device 4. When address information is not received from the image processing device 4 (No in S305), the CPU 10 stays in a standby condition until address information is received

When address information is received (Yes in S305), the CPU 10 provides a display to the effect that associating the image processing device 4 that actually performs playback processing with the address information about the image processing device 4 is completed (S307). Since the address notification information “b” received in step S305 is received only from the image processing device 4 disposed in the same room, it is obvious that the address notification information “b” shows the address of the image processing device 4 disposed in the same room. The image processing device 4 that actually performs playback processing is associated with the address information about the image processing device 4.

The CPU 10 displays, on the display 12, a list of contents stored in the storage device 5 (S309) The CPU 10 at this time provides a display in such a way that the user can select a desired content from the content list by means of an input performed by way of the keyboard, or the like.

The CPU 10 determines whether or not a content has been selected (S311). When the content is not selected No in S311), the CPU 10 stays in a standby condition until a content is selected. When a content is selected (Yes in S311), the CPU 10 issues a command for the image processing device 4 to playback the content (S113). On this occasion, as shown in FIG. 7, the CPU 10 transmits, to the image processing device 4, content acquisition command information “c” for instructing acquisition of the content selected in step S311 by way of the Ether controller 25. The content acquisition command information “c” includes ID information about the content selected in step S311 and address information about the storage device 5, and the information processing device 4 plays back the content on the basis of these pieces of information.

Content playback processing that the image processing device 4 performs on the basis of the fact of acquisition of the content acquisition command information “c” is carried out through procedures of the flowchart shown in FIG. 8, as in the first embodiment. Explanations about content playback processing are omitted.

Thus, the playback controller 3 requests address information from the plurality of image processing devices 4 through the home network 2 and receives address information from the image processing device 4 located in the same room by an optical signal, thereby associating the image processing device 4 that is to become an object of control with the address information. On the basis of the address information, the playback controller 3 causes the image processing device 4 to play back the content stored in the storage device 5.

When the address information is requested by the playback controller 3 by way of the home network 2, the image processing device 4 transmits the address information to the playback controller 3 by means of the optical signal, thereby playing back a content stored in the storage device 5 under control of the playback controller 3.

According to the second embodiment of the playback controller 3 and the image processing device 4, on controlling the image processing device 4 through the home network 2 laid in the same room, the playback controller 3 can recognize the image processing device 4 set in this room among the plurality of image processing devices similarly connected to the home network 2.

### Third Embodiment

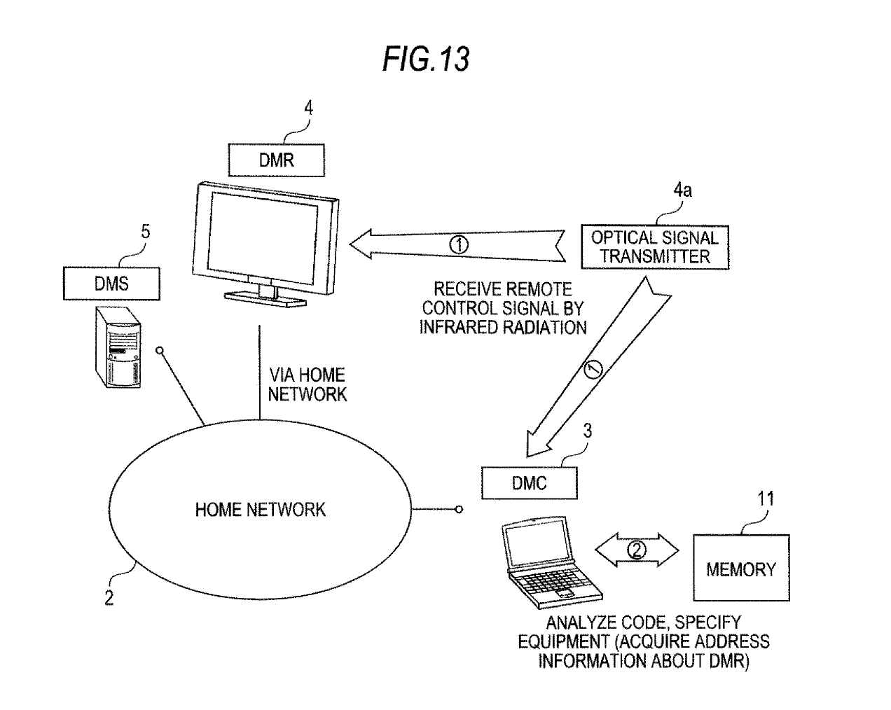

A third embodiment of the playback controller 3 and the image processing device 4 will be described by reference to FIGS. 13 through 15. There is a case where, on operating the image processing device 4, the user transmits an optical signal (a remote control signal) by use of the optical signal transmitter 4a (a remote controller, or the like, of the image processing device 4). As shown in FIG. 13, when the optical signal transmitter 4a of the image processing device 4 transmits a remote control signal, the playback controller 3 receives the remote control signal and acquires address information about the image processing signal 4 in accordance with the remote control signal, thereby subjecting the image processing device 4 to playback control processing.

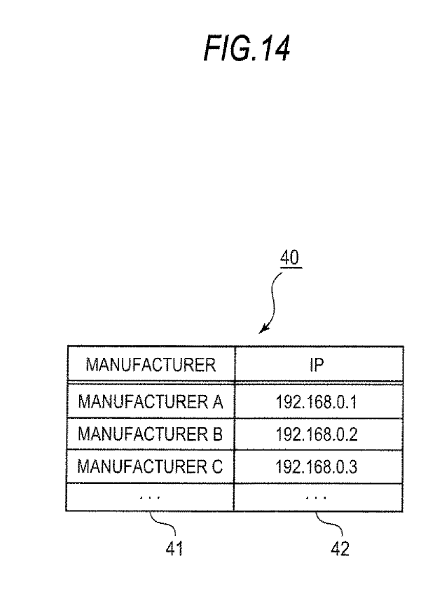

When the remote control signal is received from the image processing device 4, the memory 11 of the playback controller 3 previously stores management information 40 for associating the image processing device 4 with address information on the basis of a code included in the remote control signal. As shown in; for instance, FIG. 14, the management information 40 is information in which manufacturer information (i.e., identification information about the image processing devices 4, 4A, and 4B) represented by the code included in the remote control signal is associated with address information 42 of the image processing devices 4, 4A, and 4B that operate in accordance with the remote control signal. For instance, manufacturer information 41 about a manufacturer A is associated with address information 42 “192.168.0.1.” When the remote control signal including information representing the manufacturer A is received, the playback controller 3 associates the image processing devices 4, 4A, and 4B that perform playback with the address information “192.168.01.” The management information 40 includes information about all of the image processing devices 4, 4A, and 4B that are connected to the home network 2 and whose power is turned on.

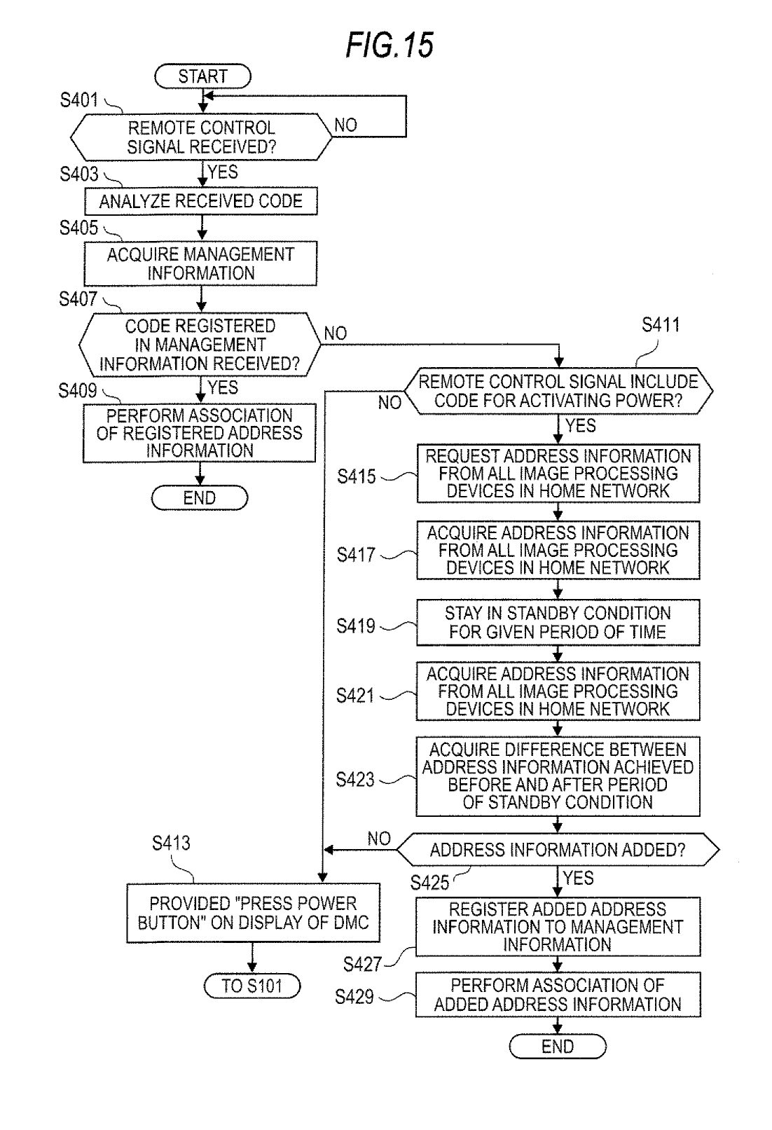

The user performs an operation on the image processing device 4 to cause the image processing device 4 to transmit an optical signal (a remote control signal) by use of the optical signal transmitter 4a. Steps of performing playback control processing by the playback controller 3 by the use of the management information 40 when the playback controller 3 receives the remote control signal from the optical signal transmitter 4a will be described by reference to a flowchart shown in FIG. 15.

The CPU 10 of the playback controller 3 first determines whether or not the remote control signal is received (S401). When the optical signal receiving section 17 has received the remote control signal, the CPU 10 determines that the remote control signal is received. When the remote control signal is not received (No in S401), the CPU 10 spontaneously enters a standby condition.

When the remote control signal is received (Yes in S401), the CPU 10 analyzes a code of the received remote control signal (S403). For instance, a code representing a manufacturer included in the remote control signal is acquired at this time. The CPU 10 also acquires the management information 40 stored in the memory 11 (S405).

The CPU 10 determines whether or not the code that was acquired in step S403 and that represents a manufacturer is registered as manufacturer information 41 in the management information 40 acquired in step S305 (S407). When the code representing the manufacturer is registered as manufacturer information 41 (Yes in S407), the CPU 10 acquires address information 42 associated with the code representing a manufacturer acquired in step S403 in the management information 40 and associates the thus-acquired address information 42 with the image processing device 4 that actually performs playback processing.

When the code representing a manufacturer is not registered as the manufacturer information 41 (No in S407), the CPU 10 determines whether or not the remote control signal received in step S401 includes a code for turning on power (S411). When the code for turning on power is not included (No in S411), the CPU 10 controls the display 12 to display text data; for instance, “Press a power button,” to thus prompt the user to turn on power (S413). The CPU 10 returns to step S401 and stays in a standby condition until a remote control signal is received.

When a code for turning on power is included (Yes in S411), the CPU 10 requests address information from all of the information processing devices 4, 4A, and 4B connected to the home network 2. As in step S303, the address request information “a” is transmitted at this time by way of the home network 2, thereby requesting address information (S415).

The CPU 10 receives address information from all of the information processing devices 4, 4A, and 4B connected to the home network 2 and stores pieces of address information in the memory 11 (S417). Similarly to the step S305, the address notification information “b” is received at this time through the home network 2.

After receiving the address information in step S417, the CPU 10 stays in a standby condition for a given period of time (e.g., 10 seconds) (S419). Specifically, the CPU 10 stays in a standby condition until the image processing device is connected to the home network 2 in consideration of elapse of a given period of time before the image processing device is connected to the home network 2 since power to the image processing device is turned on.

The CPU 10 again receives address information from all of the information processing devices 4, 4A, and 4B connected to the home network 2 in the same manner as in step S417 and stores the pieces of the address information in the memory 11 (S421).

The CPU 10 acquires a difference between the address information acquired in step S417 and the address information acquired in step S421 (S423). When the difference includes address information, the address information is address information about the image processing device connected to the home network 2 in the period during which the CPU stayed in a standby condition in step S419.

Therefore, the CPU 10 determines whether or not there is address information newly added in step S423 (S425). When there is not newly-added address information (No in S425), the CPU 10 controls the display 12 to display text data; for instance, “Press a power button,” thereby prompting the user to turn on power (S413).

When there is newly-added address information (Yes in S425), the CPU 10 associates the newly-added address information with the code acquired in step S403, thereby adding the address information to the management information 40 (S427). Further, the CPU 10 acquires, from the management information 40, the address information 42 associated with the code that was acquired in step S403 and that represents a manufacturer; and associates the address information 42 with the image processing device 4 that actually performs playback processing (S429).

Thus, the playback controller 3 receives an optical signal (a remote control signal) transmitted from the optical signal transmitter 4a (the remote controller) for remotely controlling the image processing device 4; specifies, on the basis of the management information 40 previously stored in the memory 11 of the playback controller 3, the image processing device 4 that is an object of control; and acquires address information about the image processing device 4.

The playback controller 3 ascertains a code that was transmitted from the optical signal transmitter 4a and that activates power; acquires address information about all of the image processing devices connected to the home network 2 at timing immediately after receipt of the code and at timing after elapse of a given period of time after receipt of the code; compares the address information of those two timings; and associates the added address information with the image processing device that is to be an object of control. The reason for doing this is that, since an application program is not yet launched in the image processing device immediately after power-on, an Ack signal cannot be returned in answer to the address request form the playback controller 3. In the meantime, after a sufficient standby time for starting the image processing device 4 has elapsed, the image processing device 4 can return the Ack signal in answer to the address request from the playback controller 3.

According to the third embodiment of the playback controller 3 and the image processing device 4 of the present invention, on controlling the image processing device 4 by way of the home network 2 laid in the same room, the playback controller 3 can recognize the image processing device 4 disposed in the same room among the plurality of image processing devices similarly connected to the home network 2, by use of an optical signal transmitted from the optical signal transmitter for remotely controlling the image processing device 4.

The playback controller 3 and the image processing device 4 have been described with respect to the case where a function for implementing the present invention is previously recorded in the device. However, the present invention is not limited to this case, and a similar function may also be downloaded from a network to the device, or a recording medium storing a similar function may also be installed in the device. The recording medium may also assume any form, so long as the recording medium can store a program and is readable for the device, as in CD-ROM.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback controlling apparatus communicably connectable to a plurality of image processing devices via a first communication scheme and a second communication scheme, the apparatus comprising:
a first transmission module configured to transmit request information to the image processing devices via the first communication scheme, the request information for requesting address information;
a receiving module configured to receive address information via the second communication scheme from one of the image processing devices; and
an association module configured to associate the address information with the one of the image processing devices.

2. The apparatus according to claim 1,
wherein the first communication scheme includes a communication scheme using an optical signal; and
the second communication scheme includes a communication scheme using an IP network.

3. The apparatus according to claim 1,
wherein the first communication scheme includes a communication scheme using an IP network; and
the second communication scheme includes a communication scheme using an optical signal.

4. The apparatus according to claim 1, further comprising:
a storage module configured to store a list of contents; and
a second transmission module configured to transmit the one of the image processing devices a command for playing back contents on the basis of a list of contents stored in the storage module, in accordance with the address information.

5. An image processing apparatus communicably connectable to a playback controller via a first communication scheme and a second communication scheme, the apparatus comprising:
a receiving module configured to receive request information via the first communication scheme, the request information for requesting address information from the playback controller; and
a transmission module configured to transmit address information via the second communication scheme, on receiving the request information at the receiving module.

6. The apparatus according to claim 5,
wherein the first communication scheme includes a communication scheme using an optical signal; and
the second communication scheme includes a communication scheme using an IP network.

7. The apparatus according to claim 5,
wherein the first communication scheme includes a communication scheme using an IP network; and
the second communication scheme includes a communication scheme using an optical signal.

8. A playback controlling apparatus communicably connectable to a plurality of image processing devices via an IP network to control the image processing devices, the apparatus comprising:
a storage module configured to store management information including an identification code of an optical signal transmitter for remotely operating one of the image processing devices and address information of the one of the image processing device, the address information associated with the identification code;
a first receiving module configured to receive an optical signal including the identification code from the optical signal transmitter; and
an association module configured to acquire the address information associated with the identification code in the optical signal with reference to the management information to associate the address information with the one of the image processing devices.

9. The apparatus according to claim 8, further comprising:
a second receiving module configured to receive a given optical signal from the optical signal transmitter, the given optical signal for turning on the one of the image processing devices; and
an acquisition module configured to acquire address information via the IP network from each of the image processing devices connected to the IP network;
wherein the association module compares the address information at a first timing immediately after the second receiving module receives the given optical signal with the address information at a second timing after elapse of a given period of time since the second receiving module receives the given optical signal to obtain difference information therebetween and associates the difference information with the given image processing device.
